(19) United States
(12) Patent Application Publication
(10) Pub. No.: US 2025/0292210 A1
(43) Pub. Date: Sep. 18, 2025

(54) SYSTEMS AND METHODS TO CHARACTERIZE WORK UNIT RECORDS OF A COLLABORATION ENVIRONMENT BASED ON FREEFORM ARRANGEMENT OF VISUAL CONTENT ITEMS

(71) Applicant: Asana, Inc., San Francisco, CA (US)

(72) Inventors: Alexander Thomas Ryan, San Francisco, CA (US); Micah Hanan Fenner, Amsterdam (NL)

(21) Appl. No.: 19/223,510

(22) Filed: May 30, 2025

Related U.S. Application Data
(63) Continuation of application No. 17/882,258, filed on Aug. 5, 2022, now Pat. No. 12,367,460.
(60) Provisional application No. 63/391,217, filed on Jul. 21, 2022.

(51) Int. Cl. G06Q 10/10; G06F 3/0481; G06F 3/0486

(52) U.S. Cl. CPC G06Q 10/103; G06F 3/0481; G06F 3/0486

(57) ABSTRACT

Systems and methods to characterize work unit records of a collaboration environment based on freeform arrangement of visual content items are described herein. Exemplary implementations may: manage environment state information maintaining a collaboration environment including work unit records; effectuate presentation of instances of a user interface of the collaboration environment on client computing platforms associated with the users; obtain arrangement information for the visual content items displayed in the user interface; modify, based on the arrangement information, one or more of the values of one or more of the work unit parameters for one or more of the work unit records represented by the collections of the visual content items; and/or perform other operations.

### FIELD OF THE DISCLOSURE

The present disclosure relates to systems and methods to characterize work unit records of a collaboration environment based on freeform arrangement of visual content items representing the work unit records, in particular, by translating collective spatial arrangements of the visual content items into homogenized changes to sets of the work unit records.

### BACKGROUND

Web-based collaboration environments, sometimes referred to as work management platforms, may enable users to assign projects, tasks, or other assignments to assignees (e.g., other users) to complete. A collaboration environment may comprise an environment in which individual users and/or a virtual team of users does its work and enables the users to work in a more organized and efficient manner when remotely located from each other.

### SUMMARY

Hosting a web-based collaboration environment poses many challenges. For example, operating the collaboration environment may require precise ways of creation, storage, management, and/or provision of information that makes up the collaboration environment. A way that operators look to improve the operation of the collaboration environment is to improve parts of the collaboration environment involving substantial human-machine interaction and/or parts that fall short of providing intuitive experiences for the users. For example, records for work are typically generated manually by inputting one or more of a title, assignee, collaborators, dependencies, project association, team association, and/or other fields directly into an appropriate text input box within a user interface. If there is a need to create and/or modify multiple work items at once, a user may have to switch between different views or pages of a user interface to access the fields for each individual work item. There has yet to be a user interface that allows for multiple items of work to be collectively assessed/managed, while providing a mechanism to intuitively define one or more fields for the collective work all at once.

To address these and/or other problems, one or more implementations presented herein propose a technique to characterize work unit records of a collaboration environment based on freeform arrangement of visual content items. A specially configured user interface including a digital space is provided where users freely move and position visual content items representing their work. Users may intuitively position visual content item in a manner that defines some relationships between the underlying work. By way of non-limiting illustration, a collection of visual content item within an arrangement may inform the system of relatedness of the underlying work. This may include, for example, adding the underlying work for the collection of the visual content items to a common project. By way of non-limiting illustration, a collection of visual content item forming a row arrangement may inform the system of some temporal aspects of the underlying work. By way of non-limiting illustration, aligning a collection of visual content items in a row from left to right may dictate a desired temporal order of due dates for the underlying collection of work. In short, the resulting spatial arrangements of collections of the visual content item may unlock functionality that may be applied to the underlying work. A user's freeform arrangement of the visual content item within a collection may result in modification of multiple work all at once, via this single user interface.

These, along with other features and/or functionality presented herein, may be recognized by persons of ordinary skill in the art as providing improvements upon the operation of a collaboration environment including, among others, increased efficiency and accuracy in the creation and management of records and/or the information making up the records of the collaboration environment.

One or more implementations of a system configured to characterize work unit records of a collaboration environment based on freeform arrangement of visual content items may include one or more hardware processors configured by machine-readable instructions and/or other components. Executing the machine-readable instructions may cause the one or more hardware processors to facilitate characterizing work unit records of a collaboration environment based on freeform arrangement of visual content items. The machine-readable instructions may include one or more computer program components. The one or more computer program components may include one or more of an environment state component, a user interface component, an arrangement component, and/or other components.

The environment state component may be configured to manage environment state information maintaining a collaboration environment. The collaboration environment may be configured to facilitate interaction by users with the collaboration environment. The environment state information may include one or more records. The one or more records may include user records, work unit records, and/or other information. The work unit records may define units of work managed, created, and/or assigned within the collaboration environment. The work unit records may specify values of work unit parameters characterizing the units of work. The work unit records may include one or more of a first work unit record for a first unit of work, a second work unit record for a second unit of work, and/or other work unit records.

The user interface component may be configured to effectuate presentation of instances of a user interface of the collaboration environment on client computing platforms associated with the users. The user interface may be configured to receive user input defining positions of visual content items within the user interface. Individual visual content items may represent individual units of work. By way of non-limiting illustration, a visual content item may include an icon that includes a title, graphic, or summary of the work it represents. The user interface may be configured to display the visual content items at positions defined by the user input in an arrangement of the visual content items. By way of non-limiting illustration, the user interface may be presented on a first client computing platform of a first user. The user interface on the first client computing platform may display one or more of a first visual content item representing the first work unit record at a first position defined by the user input for the first visual content item, a second visual content item representing the second work unit record at a second position defined by the user input for the second visual content item, and/or other visual content items representing other work unit records.

The arrangement component may be configured to obtain arrangement information for collections of the visual content items displayed in the user interface. The arrangement information may characterize spatial arrangements of the collections of the visual content items as displayed in the user interface. By way of non-limiting illustration, the arrangement component may obtain first arrangement information characterizing a first spatial arrangement of a collection of one or more of the first visual content item, the second visual content item, and/or other visual content items displayed on the user interface on the first client computing platform.

The environment state component may be configured to modify, based on the arrangement information and/or other information, one or more of the values of one or more of the work unit parameters for one or more of the work unit records represented by the collections of the visual content items. By way of non-limiting illustration, a first value of a first work unit parameter of the first work unit record may be modified based on the first spatial arrangement.

As used herein, any association (or relation, or reflection, or indication, or correspondency) involving servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to characterize work unit records of a collaboration environment based on freeform arrangement of visual content items, in accordance with one or more implementations.

FIG. 2 illustrates a method to characterize work unit records of a collaboration environment based on freeform arrangement of visual content items, in accordance with one or more implementations.

FIG. 3 illustrates a user interface, in accordance with one or more implementations.

### DETAILED DESCRIPTION

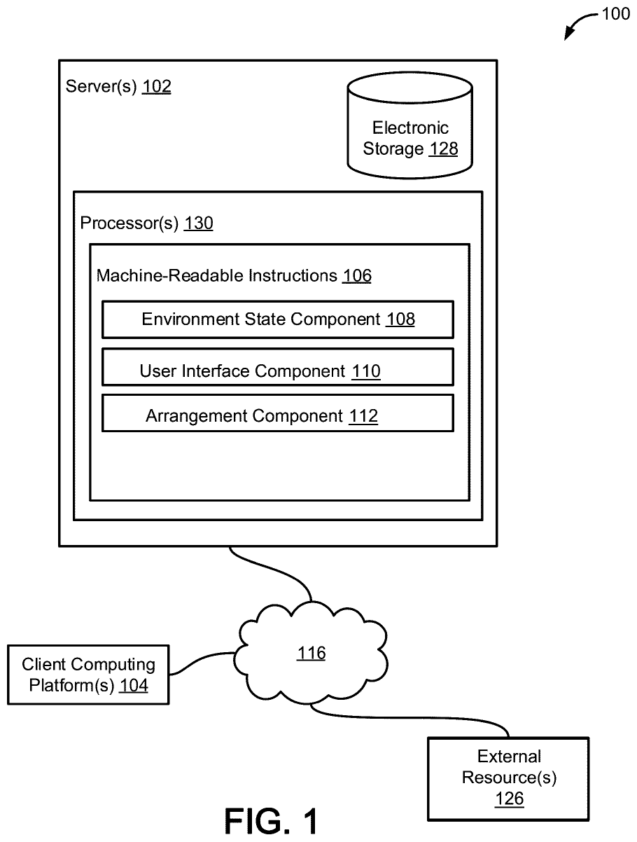

FIG. 1 illustrates a system 100 configured to characterize work unit records of a collaboration environment based on freeform arrangement of visual content items, in accordance with one or more implementations. A collection of visual content item within an arrangement may inform the system of relatedness of underlying work. The relatedness may translate into one or more homogenous changes to the information defining the underlying work within one or more work unit records.

In some implementations, system 100 may include one or more of one or more servers 102, one or more client computing platforms 104, external resource(s) 126, and/or other components. Server(s) 102 may be configured to communicate with one or more client computing platforms 104, one or more external resources 126, and/or other entities of system 100 according to a client/server architecture and/or other architectures. Client computing platform(s) 104 may be configured to communicate with other client computing platforms via server(s) 102 and/or according to a peer-to-peer architecture and/or other architectures. Users may access system 100 and/or instances of the collaboration environment via client computing platform(s) 104. Server(s) 102 may be remote from client computing platform(s) 104. Client computing platform(s) 104 may be remote from each other.

Server(s) 102 may include one or more of non-transitory electronic storage 128, one or more processors 130 configured by machine-readable instructions 106, and/or other components. The non-transitory electronic storage 128 may store one or more records and/or other information. Machine-readable instructions 106 may include one or more instruction components. The instruction components may include computer program components. Executing the machine-readable instructions 106 may cause server(s) 102 to facilitate characterizing work unit records of a collaboration environment based on freeform arrangement of visual content items. The computer program components may include one or more of an environment state component 108, user interface component 110, an arrangement component 112, and/or other components.

Environment state component 108 may be configured to manage environment state information and/or other information used in maintaining a collaboration environment. The collaboration environment may be configured to facilitate interaction by users with the collaboration environment. The environment state information may include one or more records. The one or more records may include one or more of user records, work unit records, and/or other records. The user records may include user information describing the users of the collaboration environment. The work unit records which may include work information describing units of work assigned to, created by, and/or managed by the users within the collaboration environment.

The user information in the user records may include values of user parameters and/or other information. The values of the user parameters may be organized in the user records corresponding to users interacting with and/or viewing the collaboration environment. The values of the user parameters may include information describing the users, their actions within the collaboration environment, their settings, and/or other user information; and/or metadata associated with the users, their actions within the environment, their settings, and/or other user information. Individual ones of the users may be associated with individual ones of the user records. A user record may define values of the user parameters associated with a given user.

The values of the user parameters may, by way of non-limiting example, specify one or more of: a user name, a group, a user account, user role information, a user department, descriptive user content, a to-email, a from-email, a photo, an organization, a workspace, one or more user comments, one or more teams the user belongs to, one or more of the user display settings (e.g., colors, size, project order, task order, other unit of work order, etc.), one or more authorized applications, one or more interaction parameters (e.g., indicating a user is working on/worked on a given unit of work, a given user viewed a given work unit of work, a given user selected a given unit of work, a timeframe a given user last interacted with and/or worked on a given unit of work, a time period that a given unit of work has been idle, and/or other interaction parameters), one or more notification settings, one or more progress parameters, status information for one or more work units the user is associated with (units of work assigned to the user, assigned to other users by the user, completed by the user, past-due date, and/or other information), one or more performance/productivity metrics of a given user (e.g., how many units of work the user has completed, how quickly the user completed the units of work, how quickly the user completes certain types of work units, the efficiency of the user, bandwidth of the user, activity level of the user, how many business objectives the user has helped fulfill through their completion of units of work, etc.), application access information (e.g., username/password for one or more third-party applications), one or more favorites and/or priorities, schedule information, and/or other information.

Schedule information for the individual users may include one or more calendar entries associated with the individual users. The individual calendar entries may be associated with individual start dates and individual end dates. In some implementations, schedule information may be stored locally within electronic storage 128 by virtue of features and/or functionality provided within a collaboration environment. By way of non-limiting illustration, a collaboration environment may have features and/or functionality of a calendar application configured to facilitate calendaring entries into a schedule. It is noted that schedule information may be determined through features and/or functionality provided by one or more external resources 126. By way of non-limiting illustration, external resources may include a calendar application which may be external to a collaboration environment. The collaboration environment may have permissions to access the external calendar application to determine and/or obtain schedule information.

The work information in the work unit records may include values of one or more work unit parameters and/or other information. The values of the work unit parameters may be organized in work unit records corresponding to units of work managed, created, and/or assigned within the collaboration environment. A given unit of work may have one or more assignees, owners, and/or collaborators working on the given work unit. Units of work may include one or more of tasks, projects, objectives, and/or other units of work.

Units of work may be created by a given user for the given user and/or created by the given user and assigned to one or more other users. Units of work may be created by a given user for the given user and/or created by the given user and managed by one or more other users. Tasks may include to-do items and/or action items one or more users should accomplish and/or plan on accomplishing in order to complete a task. Individual units of work may include and/or may be associated with one or more digital content items. An individual unit of work may include an individual digital content item by virtue of the individual digital content item (and/or a copy or instance thereof) being attached and/or appended thereto. A digital content item may include one or more of an image, a video, an audio file, a PDF, a word document, and/or other digital content items.

In some implementations, units of work created by, assigned to, and/or completed by the users may refer generally to a linking of the units of work with the individual users in the collaboration environment. A unit of work may be linked with a user in a manner that defines one or more relationships between the user and the unit of work. Such a relationship may connote and/or be a result of an action (past, present, and/or future) of the user with respect to the unit of work. Such actions may include one or more of creating a work unit record for a unit of work, being assigned to participate in a unit of work, participating in a unit of work, being granted access to a work unit record of a unit of work, adjusting a value of a work unit parameter of a work unit record of a unit of work, being assigned a role at the unit of work level, and/or other actions.

Individual sets of work unit records may be defined by a record hierarchy. A record hierarchy may convey individual positions of work unit records (and their corresponding units of work) in the record hierarchy. By way of non-limiting illustration, a position may specify one or more of a work unit record being superior to another work unit record, a work unit record being subordinate to another work unit record, and/or other information. As a result, individual work unit records in the individual sets of work unit records may be subordinate to other individual work unit records in the individual sets of work unit records. For example, a work unit record may define a unit of work comprising a task, and a subordinate work unit record may define a unit of work comprising a sub-task to the task. A record hierarchy may define a relationship between work unit records. A work unit record may have some restrictions placed on it by virtue of having a subordinate work unit record. By way of non-limiting illustration, a work unit record may be restricted from access (or restricted from marking complete) by one or more users unless and/or until a subordinate work unit record is completed and/or started.

Individual work unit records may include hierarchical information defining a record hierarchy of the individual work unit records. The hierarchical information of a work unit record may include one or more of information identifying other work unit records associated in a record hierarchy the work unit record belongs to, a specification of the position of the work unit record in the hierarchy, restrictions and/or other relationships placed on the work unit record by virtue of its position, and/or other information.

In some implementations, values of work unit parameters may specify one or more of a unit of work name, a unit of work description, user role information, one or more unit of work dates (e.g., a start date, a due date or end date, a completion date, and/or dates), project inclusion (e.g., identification of projects supported by the individual units of work), objective inclusion (e.g., identification of objectives supported by the individual units of work), one or more members associated with a unit of work (e.g., an owner, one or more collaborators, collaborator access information, and/or other unit of work collaborators and/or collaborator information), completion state, one or more user comment parameters (e.g., permission for who may make comments such as an assignee, an assignor, a recipient, one or more followers, and/or one or more other interested parties; content of the comments; one or more times; presence or absence of the functionality of up-votes; one or more hard-coded responses; and/or other parameters), one or more interaction parameters (e.g., indicating a given unit of work is being worked on/was worked on, a given work unit of work was viewed, a given unit of work was selected, how long the given unit of work has been idle, a last interaction parameter indicating when and what user last interacted with the given unit of work, users that interacted with the given unit of work, quantity and/or content of comments on the unit of work, and/or other interaction parameters indicating sources of the interactions, context of the interactions, content of the interactions and/or time for the interactions), one or more digital content item attachments, notification settings, privacy, an associated URL, one or more interaction parameters (e.g., sources of the interactions, context of the interactions, content of the interactions, time for the interactions, and/or other interaction parameters), updates, state of a workspace for a given unit of work (e.g., application state parameters, application status, application interactions, user information, and/or other parameters related to the state of the workspace for a unit of work), one or more performance/productivity metrics for a given unit of work, hierarchical information, dependency information, one or more custom fields (e.g., priority, cost, stage, and/or other custom fields), stage, and/or other information.

In some implementations, work unit parameters may include one or more of a work assignment parameter, work completion parameter, a work management parameter, work creation parameter, dependency parameter, grouping parameter, and/or other parameters. The values of the work assignment parameter may describe assignees of individual units of work. The values of the work management parameter may describe users who manage individual units of work and/or the extent in which they manage. The values of the work creation parameter may describe creation characteristics of individual units of work. The creation characteristics may include who created the work unit record, when it was created, and/or other information. The values of the stage parameter may characterize stage of individual ones of the units of work within workflows.

In some implementations, values of a dependency parameter may describe whether a given unit of work is dependent on one or more other units of work. A unit of work being dependent on an other unit of work may mean the unit of work may not be completed, started, assigned, and/or have other interactions performed in relation to the unit of work before some action is performed on the other unit of work. By way of nonlimiting illustration, a unit of work may not be started until another unit of work is completed, meaning the unit of work may be dependent on the other unit of work. In some implementations, values of the dependency parameter may go hand in hand with the hierarchical information. By way of non-limiting illustration, a unit of work that is subordinate to an other unit of work may be dependent on the other unit of work, or vice versa.

The values of the work assignment parameter describing assignment of users to units of work may be determined based on one or more interactions by one or more users with a collaboration environment. In some implementations, one or more users may create and/or assign one or more unit of work to themselves and/or another user. In some implementations, a user may be assigned a unit of work and the user may effectuate a reassignment of the unit of work from the user or one or more other users.

In some implementations, values of the work completion parameter may indicate that a completion status of a unit of work has changed from “incomplete” to “marked complete” and/or “complete.” In some implementations, a status of complete for a unit of work may be associated with the passing of an end date associated with the unit of work. In some implementations, a status of “marked complete” may be associated with a user providing input via the collaboration environment at the point in time the user completes the unit of work (which may be before or after an end date). In some implementations, a completion status may include one or more of “rejected,” “revisions required,” “incomplete,” and/or other statuses. By way of non-limiting illustration, for units of work that require one user to review work by another user, additional user interface elements may be presented where users can set the status as one or more of “marked complete,” “incomplete,” “rejected,” “revisions required,” and/or other statuses. In some implementations, a status of rejected for a unit of work may be associated with the passing of an end date associated with the unit of work without the work having been marked complete manually. In some implementations, a status of rejected for a unit of work may be associated with a user specifying the unit of work as rejected. In some implementations, a status of revisions required for a unit of work may be associated with a user specifying that the work being reviewed requires changes, but is otherwise approved. In some implementations, a status of revisions required may present the reviewing user with options to specify what revisions are required. In some implementations, a status of revisions required may cause a follow up unit of work to be generated which is assigned back to the assignor of the original work.

In some implementations, values of a grouping parameter may describe whether a given unit of work supports (e.g., is included in) a project and/or objective. The values may specify one or more of a name/title of another work unit record (e.g., project, objective), a name/username of an owner of another work unit record, and/or other information.

In some implementations, managing the environment state component 108 may include maintaining queues of the units of work assigned to the users. The queues may be presented to the users in a user interface of the collaboration environment to facilitate access to the units of work via work unit pages. Individual queues may represent the units of work assigned to individual users organized in an order based on the individual end dates and/or other dates (e.g., start dates) and/or other ordering. Individual queues may be presented in a user interface based on one or more of a list view, a calendar view, and/or other views. The calendar view may be a calendar view by week, by more than one week (e.g., 1^{st} through 15^{th}), by month, by more than one month (e.g., May through July), and/or other calendar views. Units of work may be represented in a calendar view by user interface elements (e.g., icons, calendar entries, etc.).

In some implementations, environment state component 108 may be configured to manage information defining work unit pages (sometimes referred to simply as “pages”) corresponding to the individual units of work. Individual work unit pages may provide access to individual units of work and/or their records. Managing information may include one or more of determining, obtaining, receiving, requesting, checking, storing, modifying, and/or other operations. Managing information defining individual work unit pages may include providing information to the user interface component 110 to effectuate presentation of the work unit pages, and/or other information. In some implementations, individual work unit pages may include individual sets of interface elements displaying the values of one or more of the work unit parameters of the individual units of work.

Users may access work unit records via the work unit pages by viewing, adding, changing, deleting, and/or otherwise interacting with values of work unit parameters stored by the work unit records. In some implementations, work unit pages providing access to tasks may be referred to as task pages; work unit pages providing access to projects may be referred to as project pages; and work unit pages providing access to objectives may be referred to as objective pages.

In some implementations, work unit records may define projects. The projects may be defined by project information and/or other information. Project information may include values of work unit parameters for projects managed within the collaboration environment. The work unit parameters for projects may be referred to as “project parameters.” The work unit parameters comprising project parameters may be specific to projects and may include one or more parameters not shared with tasks and/or objectives. The project parameters may characterize one or more projects created, owned, assigned, and/or managed within the collaboration environment and/or via the collaboration environment, and/or the metadata associated with the one or more projects. Individual ones of the projects may be associated with individual ones of the records. A given project may have one or more owners and/or one or more collaborators working on the given project. The given project may be associated with one or more other units of work assigned to one or more users under the given project heading. In some implementations, projects may include one or more units of work that may directly facilitate progress toward fulfillment of the projects. Accordingly, completion of units of work may directly contribute to progress toward fulfillment of the project. By way of non-limiting illustration, an individual project may be associated with a client, and the units of work under the individual project heading may be work directly contributing to the fulfillment of a business relationship with the client.

The values of the project parameters may, by way of non-limiting example, include one or more of: one or more units of work associated with individual ones of the projects (which may include values of other work unit parameters defined by one or more work unit records), status information, user role information, one or more user comment parameters (e.g., a creator, a recipient, one or more followers, one or more other interested parties, content, one or more times, upvotes, other hard-coded responses, etc.), a project name, a project description, one or more project dates (e.g., a start date, a due date, a completion date, and/or other project dates), one or more project collaborators (e.g., an owner, one or more other project collaborators, collaborator access information, and/or other project collaborators and/or collaborator information), one or more attachments, notification settings, privacy, an associated URL, one or more interaction parameters (e.g., sources of the interactions, context of the interactions, content of the interactions, time for the interactions, and/or other interaction parameters), updates, ordering of units of work within the given project, state of a workspace for a given task within the given project, and/or other information.

In some implementations, work unit records may define objectives. Objectives may be defined by objective information including values of one or more work unit parameters. The values of the work unit parameters may be organized in records corresponding to objectives (sometimes referred to as “business objectives”) managed, created, and/or owned within the collaboration environment. The work unit parameters corresponding to objectives may be referred to as “objective parameters.” The work unit parameters comprising objective parameters may be specific to objectives and may include one or more parameters not shared with tasks and/or projects. A given objective may have one or more collaborators, and/or team members working on the given objective. Objectives may be associated with one or more units of work one or more users should accomplish and/or plan on accomplishing. Objectives may be created by a given user for the given user and/or created by the given user and assigned to be owned to one or more other users. Individual objectives may include one or more of an individual goal, an individual sub-goal, and/or other business objectives assigned to be owned by a user and/or associated with one or more users.

The objectives may be associated with a set of units of work that may indirectly facilitate progress toward fulfillment of the objectives. The set of units of work may not directly contribute to the progress. By way of non-limiting illustration, a connection between the set of units of work and a corresponding objective may be indirect in that completion of at least one of the units of work may have no direct impact on progress toward fulfillment of the objective. The concept of “no direct impact” may mean that completion of the at least one unit of work may not cause progress toward fulfillment of the business objective without independent action outside of the at least one unit of work and/or project. Instead, the fulfillment of the at least one unit of work may make such independent action more likely (e.g., through coercion, assistance, education, incentivization, reminder, etc.). However, in some implementations, objectives may be associated with one or more units of work that may directly facilitate progress toward fulfillment of the objectives. Accordingly, completion of the set of units of work may directly contribute to the progress toward fulfillment. Objectives may be associated with an objectives and key result (OKR) goal-setting framework. Objectives may be specified on one or more of a team basis, organization basis, and/or other specifications. In some implementations, objectives may be characterized as user objectives. User objectives may be specified on an individual user basis. A user objectives may be associated with a set of units of work assigned to a user that may indirectly (and/or directly) facilitate progress toward fulfillment of the user objective.

In some implementations, objectives may be described based on one or more of a business objective name, a business objective description, one or more business objective dates (e.g., a start date, a due date, and/or dates), one or more members associated with a business objective (e.g., an owner, one or more other project/task members, member access information, and/or other business objective members and/or member information), progress information (e.g., an update, a hardcoded status update, a measured status, a progress indicator, quantity value remaining for a given business objective, completed work units in a given project, and/or other progress information), one or more interaction parameters, notification settings, privacy, an associated URL, one or more custom fields (e.g., priority, cost, stage, and/or other custom fields), and/or other information.

The values of the objective owner parameter describing objectives owned by the individual users may be determined based on one or more interactions by one or more users with a collaboration environment. In some implementations, one or more users may create and/or assign ownership of one or more objectives to themselves and/or another user. In some implementations, a user may be assigned to own an objective and the user may effectuate a reassignment of ownership of the objective from the user or one or more other users.

Progress information for the individual objectives may convey progress toward fulfillment of the individual objectives. In some implementations, the progress toward fulfillment of the business objectives may be specified as one or more of a quantitative value, a qualitative value, and/or other information. In some implementations, the quantitative value may be a percentage of completion, an integer value, a dollar amount, and/or other values. In some implementations, progress toward fulfillment of the individual objectives may be determined independently from incremental completion of the units of work associated with the individual objectives. The completion of the units of work associated with a given objective may not directly progress the given business objective toward fulfillment, but completing the units of work may make accomplishing the business objective more likely (e.g., through coercion, assistance, education, incentivization, reminder, etc.). However, in some implementations, progress toward fulfillment of the individual business objectives may be directly determined based on incremental completion of the units of work in the individual sets of units of work associated with the individual business objectives.

User role information may specify individual roles of the individual users. A role may represent a position of an individual user. The position may be specified based on a description of one or more of a job title, level, and/or other descriptions of position. The role may be specified with respect to a business organization as a whole and/or other specifications. By way of non-limiting illustration, a role may include one or more of chief executive officer (or other officer), owner, manager, supervisor, accountant, associate, employee, intern, entry level, midlevel, senior, administrator, director, foreman, engineer, product developer, human resource officer, artist, art director, and/or other descriptions.

In some implementations, user role information may specify roles of the users within the units of work. The roles may convey expected contribution of the users in completing and/or supporting the units of work. The individual roles of individual users within some units of work (e.g., a task) may be specified separately from the individual roles of the individual users within other units of work (e.g., a project associated with the task). The individual roles of individual users within the units of work may be specified separately from the individual roles of the individual users within a business organization as a whole.

In some implementations, environment state information may be continually monitored and/or updated as users interact with the collaboration environment over time. The environment state component 108 may store and/or archive the environment state information continuously, periodically, and/or based on user request to archive. The stored and/or archived environment state information may be referred to as historical environment state information and/or other information.

The user interface component 110 may be configured to effectuate presentation of instances of a user interface of the collaboration environment on client computing platform(s) 104 of the user. The user interface may provide one or more views of the collaboration environment and/or provide other features and/or functionality. The one or more views may include one or more pages of the collaboration environment and/or other views. In some implementations, an individual view of the collaboration environment may textually and/or graphically display information from one or more of a user record, a work unit record, and/or other information. By way of non-limiting illustration, a view may display one or more of a work unit page, a queue of units of work, a digital space allowing freeform arrangement of visual content item, and/or other information.

In some implementations, user interface component 110 may be configured to effectuate presentation of instances of a user interface of the collaboration environment through which visual content items representing work unit records are instantiated into a digital space and/or positioned based on user input. Instantiation into the digital space may be accomplished through drag-and-drop input and/or other mechanisms of user input that cause individual visual content item to appear in the digital space.

The user interface may include one or more user interface portions. The user interface may include one or more user interface elements configured to facilitate user interaction with the user interface. By way of non-limiting illustration, user interface elements may include one or more of text input fields, drop-down menus, check boxes, display windows, virtual buttons, icons, graphics, and/or other elements configured to facilitate user interaction.

The user interface may be configured to receive user input defining positions of visual content items within a user interface. Individual visual content items may represent individual units of work. By way of non-limiting illustration, a visual content item may include an icon that includes a title, graphic, summary, and/or other information related to the work it represents. The user interface may be configured to display the visual content items at the positions defined by the user input in an arrangement of the visual content items.

In some implementations, a digital space through which visual content items are instantiated and/or positioned may include one or more of a window of the user interface, or portion of a user interface, and/or other displays configured to facilitate positioning of visual content items therein. The digital space may be devoid of predetermined positions where visual content item may (or must) be positioned. In other words, the digital space may be an “open” space where visual content item may be positioned without restrictions, other than the bounds of the space itself. This may differ from other user interfaces that may be configured to “snap” (e.g., automatically position) icons into one or more predetermined positions upon bringing the icons at or near the individual predetermined positions. Thus, users may utilize the digital space for uninhibited, freeform, positioning of visual content item therein.

In some implementations, position may refer to a point (or set of points) on which a visual content item may sit. The positioning of a visual content item in the digital space may define an absolute position of the visual content item within to the digital space as a whole. The digital space may have degrees of freedom in two dimensions and/or other amounts of dimensions. The digital space may define one or more of an area, a volume, and/or other spaces. In some implementations, a coordinate system may be established within the digital space so that absolute position of visual content item within the area may be derived and/or measured.

The digital space may form a coordinate plane. The digital space may define a rectangular plane, circular plane, and/or other shape. A rectangular plane may have a length dimension and a height dimension. Within a coordinate system for a rectangle, a first axis may correspond to a length dimension, and a second axis may correspond to a height dimension. The first axis and the second axis may intersect at an origin of the coordinate system. In some implementations, for a rectangular space, the origin may comprise a corner (e.g., bottom left corner) of the coordinate plane, the first axis may comprise what is typically referred to as an “x-axis” and the second axis may comprise what is typically referred as a “y-axis.” In some implementations, to locate a visual content item on the coordinate plane, ordered pairs of values may be used where the ordered pair is written as (x-coordinate, y-coordinate) or (x, y), where x-coordinate represents a point on the x-axis or perpendicular distance from the y-axis and y-coordinate represents a point on the y-axis or perpendicular distance from the x-axis. The axes may measure units of distance, such that the origin starts at “zero” and the terminating end of the axis marks the bounds of the digital space and farthest distance from the origin in each direction. The units of distance may include one or more of pixels, inches, centimeters, and/or other units of distance. In some implementations, the coordinate system may or may not be visible in the digital space as it appears within the user interface on the computing platforms of the users. In some implementations, the position of a visual content item may be measured from a center point of the visual content item.

Although a rectangular coordinate system is described above, this is for illustrative purposes only. Instead, those skilled in the art may appreciate that the digital space may take on other shapes and/or may have coordinate systems defined in other ways. By way of non-limiting illustration, a polar coordinate system may be utilized for a circle-shaped digital space.

In some implementations, the digital space may include, and/or may be accompanied, by a display window including visual content items representing work unit records available to be positioned in the digital space. The display window may define a portion of the user interface from which visual content items may be selected, to thereafter by instantiated into the digital space itself, and positioned as desired by the user. In some implementations, the user interface may utilize drag-and-drop input and/or other input as a mechanism to move visual content item from the display window to the digital space. In some implementations, the display window may include a search bar (including a text input field) where users may search for other work unit records. A list of results from a search may be presented in a pop-up window and/or drop-down menu. The results may include text results that show titles for the searched-for work unit records. Upon selection of a result, a new visual content item representing a work unit record may be presented in the display window, and thereafter be made available to move into the digital space.

By way of non-limiting illustration, the user interface may be presented on a first client computing platform of a first user. The user interface on the first client computing platform may display a collection of visual content items including one or more of a first visual content item representing the first work unit record at a first position defined by user input for the first visual content item, a second visual content item representing the second work unit record at a second position defined by user input for the second visual content item, and/or other visual content items representing other work unit records.

The arrangement component 112 may be configured to obtain arrangement information for collections of the visual content items displayed in the user interface. The arrangement information may characterize spatial arrangements of collections of the visual content items positioned by the users and displayed in the user interface. The spatial arrangements of the visual content items may be characterized by one or more of absolute position of the individual visual content items, relative position of the individual visual content items, and/or other information.

Absolute position may be measured with respect to an origin of a coordinate system of the digital space. By way of non-limiting illustration, as mentioned above, absolution position may be expressed as ordered pairs of values where the ordered pair is written as (x-coordinate, y-coordinate) or (x, y), where x-coordinate represents a point on an x-axis or perpendicular distance from a y-axis and y-coordinate represents a point on the y-axis or perpendicular distance from an x-axis.

Relative position may include measures derived from absolution positions of multiple visual content item. In some implementations, relative position include measures such as one or more of proximity between two or more visual content items, directional ordering of two or more visual content items,

Proximity may comprise a measure to determine grouping or clustering arrangement of visual content item. Proximity may be measured as straight line distance between center points, edges, other portions of visual content item, and/or other points within the digital space. In some implementations, proximity between visual content item may be compared against a threshold proximity. When proximity is at or within the threshold proximity, a grouping or clustering of visual content items may be inferred. When considering a set of more than two visual content items, an imaginary center point of the set may be determined. The proximity of the visual content items to the center point may be the proximity measure that determines whether the visual content items in the set form a group cluster. If a proximity to a center point of a visual content item falls below the threshold proximity, the visual content item may not be considered a group with other visual content item having proximity to a center point that is at or below the threshold proximity.

A directional ordering arrangement may take into account positioning of multiple visual content items alone a common axis. For example, positioning of visual content items may be compared to determine whether they are aligned commonly alone a perpendicular line extending from an axis. For example, with respect to a rectangular plane, visual content items may be aligned vertically in a columnar arrangement, or horizontally in a row arrangement. With respect to direction, it may be assumed that one direction along an axis may be ascending, while the other may be descending. By way of non-limiting illustration, a direction of left to right may convey an ordering that starts on the left (e.g., left is the start) and ends on the right (e.g., right is the end). By way of non-limiting illustration, a direction of top to bottom may convey an ordering that starts on the top (e.g., top is the start) and ends on the bottom (e.g., bottom is the end).

By way of non-limiting illustration, the arrangement component 112 may obtain first arrangement information characterizing a first spatial arrangement of a collection comprising one or more of the first visual content item, the second visual content item, and/or other visual content items displayed on the user interface on the first client computing platform. The first spatial arrangement may be characterized by one or more of a first absolute position of the first visual content item, a first relative position of the first visual content item with respect to the second visual content item, a second absolute position of the second visual content item, and/or other information.

The environment state component 108 may be configured to create and/or modify, based on the arrangement information and/or other information, one or more records. By way of non-limiting illustration, one or more of values of one or more work unit parameters for one or more work unit records represented by the visual content items may be modified. By way of non-limiting illustration, one or more of values of one or more work unit parameters for one or more other work unit records may be created. In some implementations, new work unit records may be created. In some implementations, modification to records and/or creation of records may be carried out automatically in response (e.g., instantly and/or after a period of time) to determining on the arrangement information and/or other information. In some implementations, modification to records and/or creation of records may be carried out in response to obtaining further user input.

In some implementations, modifications to work unit records may include homogenous changes to one or more values. Homogenous changes may mean that the values of parameters for a set of work unit records represented by a set of visual content item in a collection are changed in the same, or similar, manner.

In some implementations, spatial arrangements of collections of visual content item may correspond to certain modifications to, and/or creation of, one or more work unit records. By way of non-limiting illustration, proximity may convey relatedness in the form of values of a grouping parameter. That is, when a set of visual content items are determined to be proximate (e.g., proximity is at or within a threshold), then the values of the grouping parameter for the underlying work unit records may be changed to reflect inclusion in a common project (or team, objective, or other group). In some implementations, this may further cause a new work unit object (e.g., a project, objective, team) to be created as a basis for the commonality. In some implementations, the common project (or other group) may be selected from a project that one of the work unit records represented by the visual content items may already be a part of. By way of non-limiting illustration, a centermost visual content item may represent a work unit record that is part of an existing group. When other visual content items are clustered around that visual content item, the work unit records of the other visual content items may be modified to also reflect inclusion in the existing group.

By way of non-limiting illustration, directional ordering may convey relatedness in dates (due dates, start dates, end date, etc.). That is, when a set of visual content items are determined to have a directional ordering (e.g., aligned vertically or horizontally), then the values of a date parameter for the underlying work unit records may be changed to reflect the directional ordering. The directional ordering may be associated with a sequential order of dates. Upon identifying the direction order, the dates of the work unit records may be changed to follow the sequential order. For example, a directional order of visual content items from left to right may convey a desired timeline for completion of the underlying work, where the leftmost visual content item conveys an earliest date, and the rightmost visual content item conveys a later date. In some implementations, a sequential order of dates may include successive dates, dates spread out by a predetermined duration (e.g., dates that are two weeks apart), and/or other specifications. Some of these characteristics may be specified by a user ahead of time.

By way of non-limiting illustration, directional ordering may convey relatedness in dependency. That is, when a set of visual content items are determined to have a direction ordering (e.g., aligned vertically or horizontally), then the values of a dependency parameter for the underlying work unit records may be changed to reflect the directional ordering. The directional ordering may be associated with a hierarchy. Upon identifying the directional ordering, the dependency of the underlying work unit records may changed to follow the hierarchy. For example, a directional order of visual content items from top to bottom may convey a desired hierarchy, where the topmost visual content item conveys a highest order within the hierarchy, and the bottommost visual content item conveys a lowest order within the hierarchy. By way of non-limiting illustration, a columnar ordering of two visual content items may cause the work unit record associated with the bottom visual content item to be dependent on the work unit record associated with the top visual content item.

By way of non-limiting illustration, responsive to the relative position of two or more of the visual content items conveying proximity between the two or more of the visual content items is at or below a proximity threshold, environment state component 108 may be configured to homogenize the values of a given work unit parameter for the work unit records represented by the two or more of the visual content items. In some implementations, the given work unit parameter may comprise a grouping parameter such that homogenizing the values causes the work unit records to be associated with a common group.

By way of non-limiting illustration, responsive to the relative position of two or more of the visual content items conveying a directional ordering of the two or more of the visual content items, environment state component 108 may be configured to modify the values of a given work unit parameter for the work unit records represented by the two or more of the visual content items in accordance with the directional ordering. In some implementations, the given work unit parameter may be a due date parameter such that modifying the values for the work unit records represented by the two or more of the visual content items comprises setting the values to a sequential order of dates. In some implementations, the given work unit parameter may be a dependency parameter such that modifying the values for the work unit records represented by the two or more of the visual content items comprises setting the values to convey a hierarchy of dependency.

In some implementations, one or more areas within the digital space may be pre-associated with one or more modifications. By way of non-limiting illustration, a user may trace out an area (e.g., a square in a corner of the space), and specify that visual content item placed within that area cause the underlying work unit records to be modified in a predetermined manner. The predetermined manner may include, for example, one or more of inclusion in a common group, assignment/reassignment to a particular user (or role), changing due date (e.g., pushing due date out two weeks, etc.). Other predetermined modifications may be designated for particular areas within the digital space.

In some implementations, responsive to the absolute position of the individual ones of the visual content items being within a predetermined area on the user interface, environment state component 108 may be configured to modify the values of a given work unit parameter for the work unit records represented by the individual ones of the visual content items within the predetermined area by a predetermined modification.

By way of non-limiting illustration, a first value of a first work unit parameter of the first work unit record may be modified based on the first spatial arrangement. In some implementations, responsive to the first relative position conveying the proximity between the first visual content item and the second visual content item is at or below a proximity threshold, the values of the first work unit parameter for one or both of the first work unit record and the second work unit record may be homogenized (e.g., set to the same value). In some implementations, responsive to the first relative position conveying a first directional ordering of the first visual content item and the second visual content item, the values of the first work unit parameter for one or both of the first work unit record and the second work unit record may be modified to reflect the first directional ordering. In some implementations, responsive to the first absolute position falling within a first predetermined area, the first value of the first work unit parameter may be modified in accordance with a first predetermined modification.

In some implementations, responsive to obtaining the arrangement information and prior to modifying the values by the environment state component 108, user interface component 110 may be configured to generate record modification notifications. The record modification notifications may convey recommendations to modify one or more of the values of the one or more of the work unit parameters based on the arrangement information and/or other information. The record modification notification may include user interface elements (e.g., virtual buttons) which, upon selection, allow a user to approve or deny the recommendation. Approval of the recommendation may cause changes to be carried out for the work unit records (or creations of new records) automatically and simultaneously.

The user interface component 110 may be configured to effectuate presentation of the record modification notifications on the client computing platform(s) 104 associated with the users. The record modification notifications may be presented as pop-windows, private messages, and/or other types of communications.

In some implementations, responsive to obtaining approval, via user input in the record modification notifications, environment state component 108 may be configured to execute the recommended modifications.

In some implementations, the arrangement component 112 may be configured to learn, for individual users and/or teams of users, associations between spatial arrangements of collections of visual content items and the modifications/creations that are derived therefrom. For example, using machine learning, heuristics, and/or other techniques, the arrangement component 112 may be configured to monitor work unit records for changes made manually by users after modifications have been made from the spatial arrangements. Based on those modifications, the arrangement component 112 may be configured to adapt what modifications and/or creations are made based on the arrangement information and/or other information. By way of non-limiting illustration, arrangement component 112 may be configured to initially correlate clustering of visual content item to grouping the underlying work in a common project. Based on subsequent monitoring of the underlying work, it may turn out that the user ends up changing the grouping to a common objective, as opposed to project. Thus, the arrangement component 112 may be adapted for that user to now correlate clustering of visual content item to grouping the underlying work in a common objective. Other adaptations may be made based on subsequent monitoring of the underlying work.

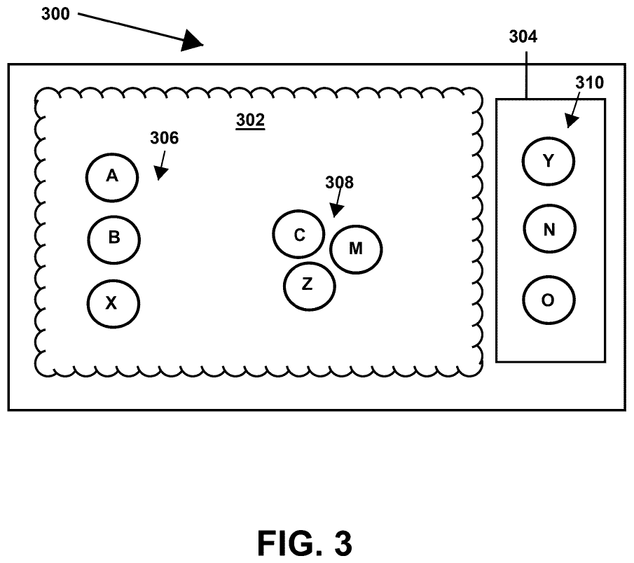

FIG. 3 illustrates a user interface 300 of a collaboration environment, in accordance with one or more implementations. The user interface 300 may include a view of a collaboration environment. In particular, the user interface 300 may comprise a digital space 302 upon which visual content items may be positioned by user input. For illustrative purposes, the visual content items are presented by circular icons, labeled, A, B, C, M, N, O, X, Y, and Z. The user interface 300 may include a display window 304 displaying a set 310 of visual content items available to be added to the digital space 302. The individual visual content items may present individual units of work. The user interface 300 may display the visual content items at positions defined by the user input in an arrangement of a collection of the visual content items. Arrangement information may characterize spatial arrangement(s) of the collection of the visual content items as displayed in the user interface 300. By way of non-limiting illustration, upon user positioning, the collection of visual content items may be characterized by spatial arrangement(s) of a first set 306 of the visual content items (A, B, and X), and a second set 308 of the visual content items (C, M, and Z). The first set 306 may have directional ordering arrangement by virtue of the vertical alignment of the visual content items A, B, and X. The second set 308 may have a grouping or clustering arrangement by virtue of the proximity of visual content items C, M, and Z to one another. In some implementations, the directional ordering of visual content items A, B, and X may cause one or more values of one or more work unit parameters of the underlying work to be modified and/or created. By way of non-limiting illustration, a task associated with visual content item X may be made dependent on a task associated with visual content item B, which may be made dependent on a task associated with visual content item C. In some implementations, the clustering of visual content items C, M, and Z may cause one or more values of one or more work unit parameters of the underlying work to be modified and/or created. By way of non-limiting illustration, projects associated with visual content items C, M, and Z may be defined as supporting a common objective.

Referring back to FIG. 1, in some implementations, server(s) 102, client computing platform(s) 104, and/or external resources 126 may be operatively linked via one or more electronic communication links. For example, such electronic communication links may be established, at least in part, via a network 116 such as the Internet and/or other networks. It will be appreciated that this is not intended to be limiting, and that the scope of this disclosure includes implementations in which server(s) 102, client computing platform(s) 104, and/or external resource(s) 126 may be operatively linked via some other communication media.

A given client computing platform may include one or more processors configured to execute computer program components. The computer program components may be configured to enable an expert or user associated with the given client computing platform to interface with system 100 and/or external resource(s) 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resource(s) 126 may include sources of information outside of system 100, external entities participating with system 100, and/or other resources. In some implementations, some or all of the functionality attributed herein to external resource(s) 126 may be provided by resources included in system 100.

Server(s) 102 may include electronic storage 128, one or more processors 130, and/or other components. Server(s) 102 may include communication lines, or ports to enable the exchange of information with a network 116 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, a physical processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, and/or other components. Processor(s) 130 may be configured to execute components 108, 110, 112, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, and/or 112 are illustrated in FIG. 1 as being implemented within a single processing unit, in implementations in which processor(s) 130 includes multiple processing units, one or more of components 108, 110, and/or 112 may be implemented remotely from the other components. The description of the functionality provided by the different components 108, 110, and/or 112 described below is for illustrative purposes, and is not intended to be limiting, as any of components 108, 110, and/or 112 may provide more or less functionality than is described. For example, one or more of components 108, 110, and/or 112 may be eliminated, and some or all of its functionality may be provided by other ones of components 108, 110, and/or 112. As another example, processor(s) 130 may be configured to execute one or more additional components that may perform some or all of the functionality attributed below to one of components 108, 110, and/or 112.

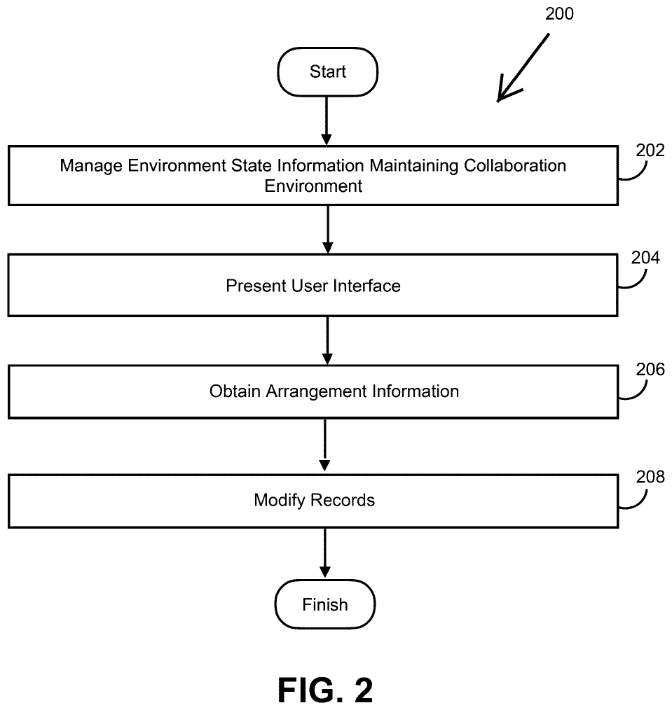

FIG. 2 illustrates a method 200 to characterize work unit records of a collaboration environment based on freeform arrangement of visual content items, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may manage environment state information maintaining a collaboration environment. The collaboration environment may be configured to facilitate interaction by users with the collaboration environment. The environment state information may include one or more records. The one or more records may include user records, work unit records, and/or other information. The work unit records may define units of work managed, created, and/or assigned within the collaboration environment. The work unit records may specify values of work unit parameters characterizing the units of work. The work unit records may include one or more of a first work unit record for a first unit of work, a second work unit record for a second unit of work, and/or other work unit records. Operation 202 may be performed by one or more hardware processors configured by machine-readable instructions including a component that is the same as or similar to environment state component 108, in accordance with one or more implementations.

An operation 204 may effectuate presentation of instances of a user interface of the collaboration environment on client computing platforms associated with the users. The user interface may be configured to receive user input defining positions of visual content items within the user interface. Individual visual content items may represent individual units of work. By way of non-limiting illustration, a visual content item may include an icon that includes a title, graphic, or summary of the work it represents. The user interface may be configured to display the visual content items at positions defined by the user input in an arrangement of the visual content items. By way of non-limiting illustration, the user interface may be presented on a first client computing platform of a first user. The user interface on the first client computing platform may display one or more of a first visual content item representing the first work unit record at a first position defined by the user input for the first visual content item, a second visual content item representing the second work unit record at a second position defined by the user input for the second visual content item, and/or other visual content items representing other work unit records. Operation 204 may be performed by one or more hardware processors configured by machine-readable instructions including a component that is the same as or similar to user interface component 110, in accordance with one or more implementations.

An operation 206 may obtain arrangement information for collections of the visual content items displayed in the user interface. The arrangement information may characterize spatial arrangements of the collections of the visual content items as displayed in the user interface. By way of non-limiting illustration, the arrangement component may obtain first arrangement information characterizing a first spatial arrangement of a collection of one or more of the first visual content item, the second visual content item, and/or other visual content items displayed on the user interface on the first client computing platform. Operation 206 may be performed by one or more hardware processors configured by machine-readable instructions including a component that is the same as or similar to arrangement component 112, in accordance with one or more implementations.

An operation 208 may modify, based on the arrangement information and/or other information, one or more records. The modification may include modification of one or more of the values of one or more of the work unit parameters for one or more of the work unit records represented by the collections of the visual content items. By way of non-limiting illustration, a first value of a first work unit parameter of the first work unit record may be modified based on the first spatial arrangement. Operation 208 may be performed by one or more hardware processors configured by machine-readable instructions including a component that is the same as or similar to environment state component 108, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed:

1. A system configured to characterize work unit records of a collaboration environment based on freeform arrangement of visual content items, the system comprising:
one or more physical processors configured by machine-readable instructions to:
manage environment state information maintaining a collaboration environment, the collaboration environment being configured to facilitate interaction by users with the collaboration environment, the environment state information including work unit records, the work unit records including work information describing units of work managed, created, and/or assigned within the collaboration environment, the work unit records including a first work unit record for a first unit of work, and a second work unit record for a second unit of work;
effectuate presentation of an instance of a user interface of the collaboration environment on a client computing platform associated a user, the instance of the user interface displaying a first visual content item representing the first work unit record, and a second visual content item representing the second work unit record, the first visual content item being at a first position, the second visual content item being at a second position, the first position and the second position being defined based on user input into the instance of the user interface;
obtain arrangement information characterizing a spatial arrangement of the first visual content item and the second visual content item; and
modify the work information of the first work unit record and/or the second work unit record based on the spatial arrangement.

2. The system of claim 1, wherein the spatial arrangement is characterized by one or more of a first absolute position of the first visual content item, a relative position of the first visual content item with respect to the second visual content item, or a second absolute position of the second visual content item.

3. The system of claim 2, wherein the one or more physical processors are further configured by the machine-readable instructions to:
responsive to the relative position being at or below a proximity threshold, homogenize the work information of the first work unit record and the second work unit record.

4. The system of claim 3, wherein homogenizing the work information of the first work unit record and the second work unit records includes specifying association within a common group.

5. The system of claim 2, wherein the one or more physical processors are further configured by the machine-readable instructions to:
responsive to the relative position conveying a directional ordering of the first visual content item and the second visual content item, modify the work information of the first work unit record and/or the second work unit record based on the directional ordering.

6. The system of claim 5, wherein the work information modified based on the directional ordering includes due dates.

7. The system of claim 2, wherein the one or more physical processors are further configured by the machine-readable instructions to:
responsive to the first absolute position falling within a first predetermined area, modify the work information of the first work unit record based on a first predetermined modification.

8. The system of claim 1, wherein the one or more physical processors are further configured by the machine-readable instructions to:
responsive to obtaining the arrangement information and prior to modifying the work information, generate a modification notification;
effectuate presentation of the modification notification; and
responsive to obtaining approval, via further user input in the modification notification, execute modification to the work information of the first work unit record and/or the second work unit record.

9. The system of claim 1, wherein the user interface comprises a digital space that is part of the collaboration environment.

10. The system of claim 9, wherein the user input into the instance of the user interface includes drag-and-drop input into the digital space.

11. A method to characterize work unit records of a collaboration environment based on freeform arrangement of visual content items, the method comprising:
managing environment state information maintaining a collaboration environment, the collaboration environment being configured to facilitate interaction by users with the collaboration environment, the environment state information including work unit records, the work unit records including work information describing units of work managed, created, and/or assigned within the collaboration environment, the work unit records including a first work unit record for a first unit of work, and a second work unit record for a second unit of work;
effectuating presentation of an instance of a user interface of the collaboration environment on a client computing platform associated a user, the instance of the user interface displaying a first visual content item representing the first work unit record, and a second visual content item representing the second work unit record, the first visual content item being at a first position, the second visual content item being at a second position, the first position and the second position being defined based on user input into the instance of the user interface;
obtaining arrangement information characterizing a spatial arrangement of the first visual content item and the second visual content item; and
modifying the work information of the first work unit record and/or the second work unit record based on the spatial arrangement.

12. The method of claim 11, wherein the spatial arrangement is characterized by one or more of a first absolute position of the first visual content item, a relative position of the first visual content item with respect to the second visual content item, or a second absolute position of the second visual content item.

13. The method of claim 12, further comprising:
responsive to the relative position being at or below a proximity threshold, homogenizing the work information of the first work unit record and the second work unit record.

14. The method of claim 13, wherein the homogenizing the work information of the first work unit record and the second work unit records includes specifying association within a common group.

15. The method of claim 12, further comprising:
responsive to the relative position conveying a directional ordering of the first visual content item and the second visual content item, modifying the work information of the first work unit record and/or the second work unit record based on the directional ordering.

16. The method of claim 15, wherein the work information modified based on the directional ordering includes due dates.

17. The method of claim 12, further comprising:
responsive to the first absolute position falling within a first predetermined area, modifying the work information of the first work unit record based on a first predetermined modification.

18. The method of claim 11, further comprising:
responsive to obtaining the arrangement information and prior to modifying the work information, generating a modification notification;
effectuating presentation of the modification notification; and
responsive to obtaining approval, via further user input in the modification notification, performing the modifying of the work information of the first work unit record and/or the second work unit record.

19. The method of claim 11, wherein the user interface comprises a digital space that is part of the collaboration environment.

20. The method of claim 19, wherein the user input into the instance of the user interface includes drag-and-drop input into the digital space.
